(19) United States
(12) Patent Application Publication
(10) Pub. No.: US 2024/0377612 A1
(43) Pub. Date: Nov. 14, 2024

(54) ACTUATOR FOR REFLECTOR

(71) Applicant: JAHWA electronics Co., Ltd., Cheongju-si (KR)

(72) Inventor: Jae Yong GO, Chungju-si (KR)

(21) Appl. No.: 18/599,231

(22) Filed: Mar. 8, 2024

(30) Foreign Application Priority Data
May 12, 2023 (KR) 10-2023-0061406

(51) Int. Cl. G02B 7/182; G02B 13/00; H01F 7/14

(52) U.S. Cl. CPC G02B 7/1821; G02B 13/0065; H01F 7/14

(57) ABSTRACT

An actuator for a reflector. The actuator includes: a carrier at which a reflector is installed; first and second magnets installed at the carrier and placed in directions perpendicular to each other, a ball guide configured to support rotational movement of the carrier in a first direction; a first ball placed between the carrier and the ball guide; a housing configured to support rotational movement of the ball guide in a second direction perpendicular to the first direction; and a second ball placed between the ball guide and the housing.

### TECHNICAL FIELD

The present disclosure relates to an actuator for a reflector, and more specifically, to an actuator for a reflector, which further improves driving precision by improving the structure that supports rotational movement of a carrier.

### BACKGROUND ART

Advances in hardware technology for image processing and growing consumer need for making and taking photos and videos have driven implementation of such functions as autofocusing (AF) and optical image stabilization (OIS) in stand-alone cameras as well as camera modules mounted on mobile terminals including cellular phones and smartphones.

An autofocus (AF) function (or, an automatically focusing function) means a function of a focal length to a subject by linearly moving a carrier having a lens in an optical axis direction to generate a clear image at an image sensor (CMOS, CCD, etc.) located at the rear of the lens.

In addition, an optical image stabilization (OIS) function means a function of improving the sharpness of an image by adaptively moving the carrier having a lens in a direction to compensate for the shaking when the lens is shaken due to trembling.

One typical method for implementing the AF or OIS function is to install a magnet (a coil) on a mover (a carrier) and install a coil (a magnet) on a stator (a housing, or another type of carrier, or the like), and then generate an electromagnetic force between the coil and the magnet so that the mover moves in the optical axis direction or in a direction perpendicular to the optical axis.

Recently, mobile terminals are equipped with zoom lenses with specifications such as the ability to variably adjust the focal length or capture images from a distance in order to meet ever-increasing user needs and implement more diverse user convenience.

The zoom lenses have a structure in which a plurality of lenses or lens groups are arranged side by side or the lens itself has a long length in the optical axis direction, so a larger mounting space must be provided in the mobile terminal.

Recently, in order to organically combine the physical characteristics of the zoom lens with the geometrical characteristics of the mobile terminal, an actuator or camera module with a physical structure that refracts the light of the subject using a reflector placed at the front of the lens has been disclosed.

The actuator or the like that employs a reflector implements OIS by moving the reflector, which reflects the light of the subject toward the lens, along one or two axes, rather than stabilizing and moving the lens, when shaking occurs.

Typically, such an actuator or device is equipped with a plurality of moving elements for independent rotation in each direction, and a magnet for driving in each direction is installed in each of these moving elements.

Therefore, in the conventional actuator, a plurality of moving elements must make rotational movement relative to each other, so they are not physically fixed. Thus, each moving element is affected by the magnetic field generated between the magnet installed on itself and the magnet installed on another moving element.

Due to these structural problems, in the conventional actuator, the posture and position of the moving element have dynamic time-changing behavior characteristics, which may lead to reduced driving precision.

Meanwhile, in the conventional actuator, when a structure in which the moving element makes rotational movement along a rail or the like while being supported by a ball placed between the moving element and the stator is applied, a yoke made of a magnetic material to generate an attractive force with the magnet in order to maintain contact force or adhesion force with the ball is generally provided.

However, in the conventional actuator, since the rotation directions of the moving elements are perpendicular, the yoke must be provided in each direction, and also the attractive force may be weakened due to mutual interference of magnetic forces.

### SUMMARY

### Technical Problem

The present disclosure is designed to solve the problems of the related art, and therefore the present disclosure is directed to providing an actuator for a reflector, which may fundamentally eliminate the influence of mutual magnetic forces generated between magnets by improving the structure of moving elements that physically support the movement of a reflector in each direction, and may also more effectively implement the adhesion force between the moving element and the stator with a ball interposed therebetween.

Other technical goals and advantages of the present invention can be understood with reference to the description below, which will be made explicit by the accompanied examples. Furthermore, the technical goals and advantages of the present invention can be accomplished by the embodiments and their combinations recited in the attached claims.

### Technical Solution

An actuator for a reflector according to an embodiment of the present disclosure to accomplish the above object may comprise a carrier at which a reflector is installed; first and second magnets installed at the carrier and placed in directions perpendicular to each other; a ball guide configured to support rotational movement of the carrier in a first direction; a first ball placed between the carrier and the ball guide; a housing configured to support rotational movement of the ball guide in a second direction perpendicular to the first direction; and a second ball placed between the ball guide and the housing.

Here, the ball guide of the present disclosure may have a first space that is a space where the second magnet is exposed.

In this case, the second magnet of the present disclosure may be installed at the carrier to protrude outward, and the ball guide of the present disclosure may face the carrier in such a way that the second magnet enters the first space.

Preferably, the actuator for a reflector of the present disclosure may further comprise a yoke plate provided in the housing and configured to generate an attractive force with the second magnet exposed through the first space.

In addition, the carrier and the ball guide of the present disclosure may be placed side by side in the same direction, and in this case, the yoke plate of the present disclosure may provide an adhesion force between the carrier and the ball guide with the first ball interposed therebetween and between the ball guide and the housing with the second ball interposed therebetween together by the attractive force with the second magnet.

Depending on the embodiment, the ball guide of the present disclosure may include a rounded first rail where the first ball is placed, wherein the first rail is provided on a first surface, which is a surface facing the carrier, and is provided outside the first space.

In addition, the ball guide of the present disclosure may further include a rounded second rail where the second ball is placed, wherein the second rail is provided on a second surface, which is a surface opposite to the first surface, and is provided outside the first space.

### Advantageous Effects

According to a preferred embodiment of the present disclosure, the overall structure for rotating the reflector may be further simplified through structural improvements that may implement rotation in both the first and second directions by mounting a plurality of magnets that respectively drive rotation in the first and second directions at a single carrier.

According to an embodiment of the present disclosure, the mutual influence of magnetic forces caused by magnets respectively provided in the dual moving elements may be essentially resolved, thereby further improving the driving precision and driving independence of rotational movement in each direction.

According to an embodiment of the present disclosure, since structures that allow rotational movement of the reflector in multiple directions may be arranged side by side in the front and rear directions or in the upper and lower directions based on one axis, structural simplicity may be achieved, and also it is possible to give the effect of simultaneously bringing balls with different functions, which support rotational movement in each direction, into close contact with objects, which are physically in contact with the balls, by using a single yoke.

According to an embodiment of the present disclosure, by applying a structure in which the magnet installed at the carrier enters the ball guide, the space efficiency of the actuator itself may be increased, and also the attractive force efficiency by the yoke plate may be maximized.

### BRIEF DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIGS. 1 and 2 are diagrams showing the overall configuration of an actuator for a reflector and a camera module according to a preferred embodiment of the present disclosure,

FIGS. 3 and 4 are exploded views showing the detailed configuration of the actuator for a reflector according to a preferred embodiment of the present disclosure,

FIG. 5 is a diagram for illustrating the operational relationship in which the reflector rotates in a first direction,

FIG. 6 is a diagram for illustrating the operational relationship in which the reflector rotates in a second direction,

FIGS. 7 and 8 are diagrams showing the close contact between a carrier, a first ball, a ball guide, and a second ball,

FIG. 9 is a diagram showing the overall configuration of an actuator for a reflector and a camera module according to another embodiment of the present disclosure, and

FIG. 10 is an exploded view showing the detailed configuration of the actuator for a reflector, depicted in FIG. 9.

### DETAILED DESCRIPTIONS OF EXEMPLARY EMBODIMENTS

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

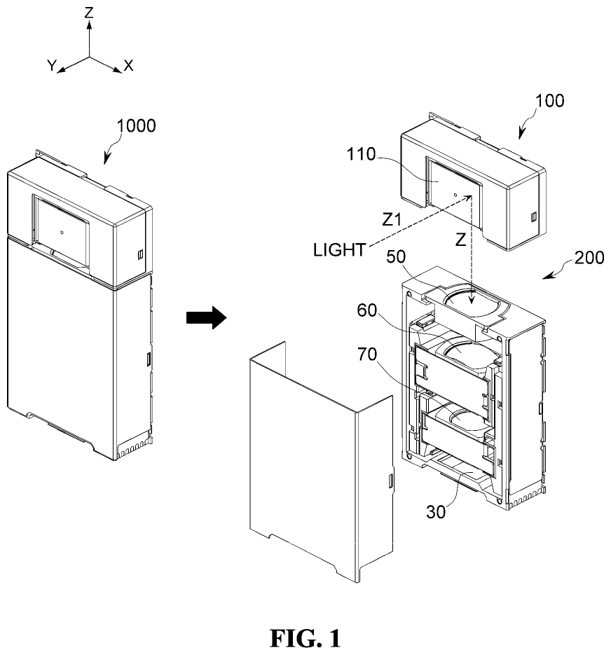

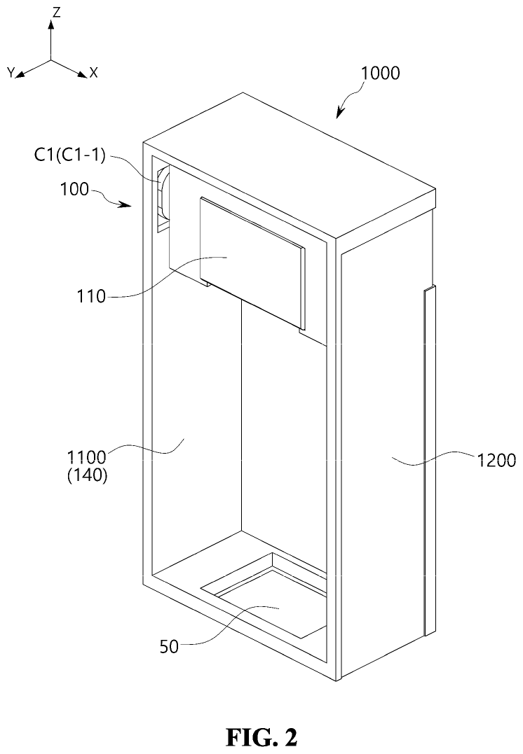

FIGS. 1 and 2 are diagrams showing the overall configuration of an actuator 100 for a reflector (hereinafter, referred to as an ‘actuator’) and a camera module 1000 according to a preferred embodiment of the present disclosure.

The actuator 100 of the present disclosure may be implemented as a single device, and as shown in FIG. 1, may be implemented in the form of a camera module 1000 including at least one lens 50, 60, 70, a lens driving module 200 for implementing zoom, autofocus (AF), or the like, and an image sensor 30.

In the actuator 100 of the present disclosure, the light of a subject does not flow directly into the lens 50, 60, 70, but the actuator 100 is configured such that the light of a subject flows into the lens 50, 60, 70 after changing (refracting, reflecting, or the like) the path of light through a reflector 110 provided in the actuator 100 of the present disclosure.

As illustrated in FIG. 1, the path of light coming from the outside is Z1, and the path of light coming from the outside and flowing into the lens 50, 60, 70 after being refracted or reflected by the reflector 110 is Z.

In the following description, Z-axis direction corresponding to the direction in which light flows into the lens 50, 60, 70 is referred to as an optical axis or an optical axis direction, and two directions perpendicular to the Z-axis direction are referred to as X-axis and Y-axis.

Based on the optical axis direction, an image sensor 30 such as CCD or CMOS that converts light signals into electrical signals may be provided at the rear end of the lens 50, 60, 70, and a filter that blocks or transmits light signals in a specific band may be provided together. Of course, the number and location of lenses 50, 60, 70 may be different from those shown in the drawings depending on the embodiment.

As will be described in detail later, the actuator 100 of the present disclosure corresponds to a device that implements OIS for the X-axis direction or/and Y-axis direction by rotating the reflector 110 in a direction that compensates for the movement when shaking due to hand tremor occurs based on the X-axis direction and/or Y-axis direction perpendicular to the optical axis.

As illustrated in FIG. 1, the actuator 100 of the present disclosure may be implemented as an independent device and combined with other devices constituting the camera module 1000, and may also be implemented in various forms, such as being included inside a housing 1100 of the camera module 1000 as illustrated in FIG. 2 or the like.

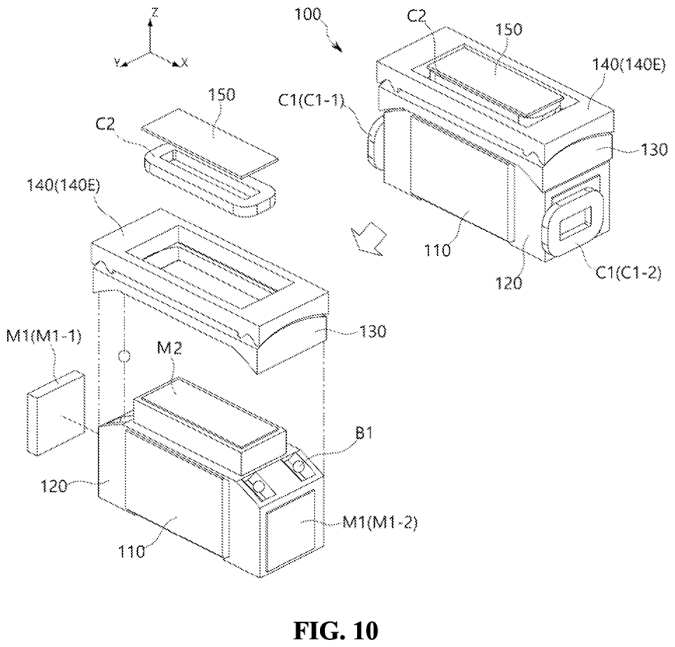

In this case, a housing 140, which is a component of the actuator 100, may be the housing of the actuator 100 itself or the housing 1100 of the camera module 1000, and as illustrated in FIG. 10, the it housing 140 may also be implemented with a support 140E installed as an extension of the housing 1100 for structural improvement.

The axes shown in the drawings, terms referring to the axes, and terms such as “upper”, “lower”, “front”, “rear”, “vertical”, “horizontal”, or the like described with respect to the axes are intended to present a relative standard for describing an embodiment of the present disclosure, and it is obvious that these terms are not intended to specify any direction or location on an absolute basis. Of course, these terms may vary relatively depending on the location of a target object, the location of an observer, the viewing direction, or the like.

In the following description of the present disclosure, the direction axis corresponding to the path through which light enters the lens, namely the direction axis corresponding to the vertical length direction of the lens, is defined as an optical axis (Z-axis), and two axes on the plane perpendicular to the optical axis (Z-axis) are defined as X-axis and Y-axis.

Hereinafter, an embodiment of the present disclosure will be described by defining the Z-axis as a standard for the upper and lower direction or the vertical direction, and from a corresponding perspective, an embodiment of the present disclosure will be described by defining the Y-axis as a standard for the front or rear direction and defining the X-axis as a standard for the left or right direction.

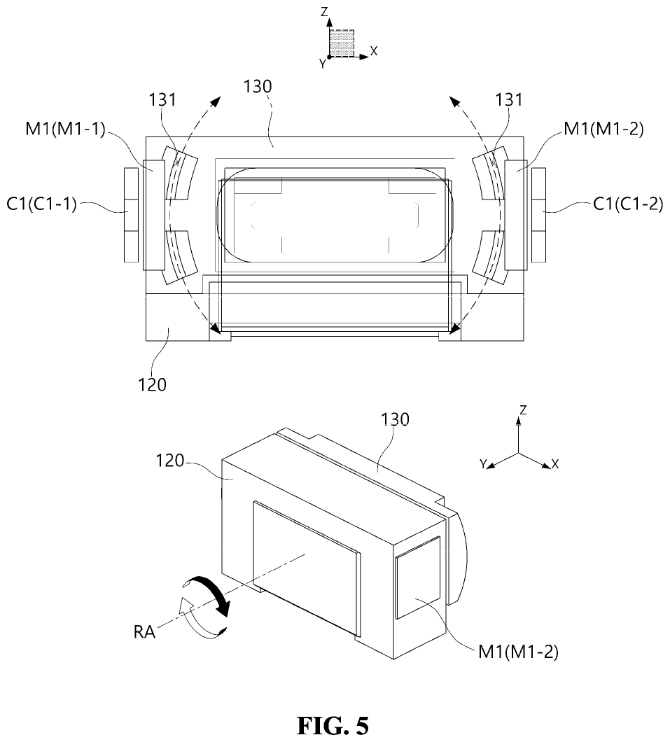

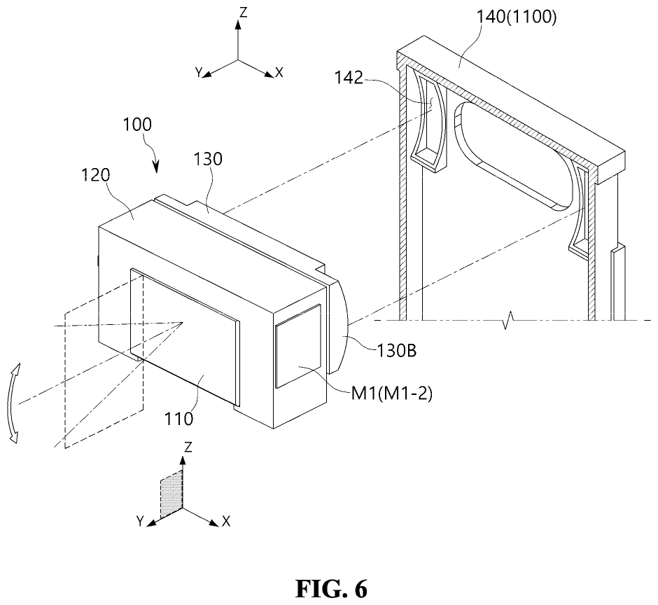

Based on the actuator 100 according to an embodiment of the present disclosure, as will be explained later, the XZ plane or a corresponding plane becomes a plane direction (see FIG. 5) in which the carrier 120 rotates based on the Y-axis direction as a rotation axis (RA) with the ball guide 130 as a relative stator, and the YZ plane becomes a plane direction (see FIG. 6) in which the carrier 120 of the present disclosure rotates with respect to the housing 140, 1100 together with the ball guide 130.

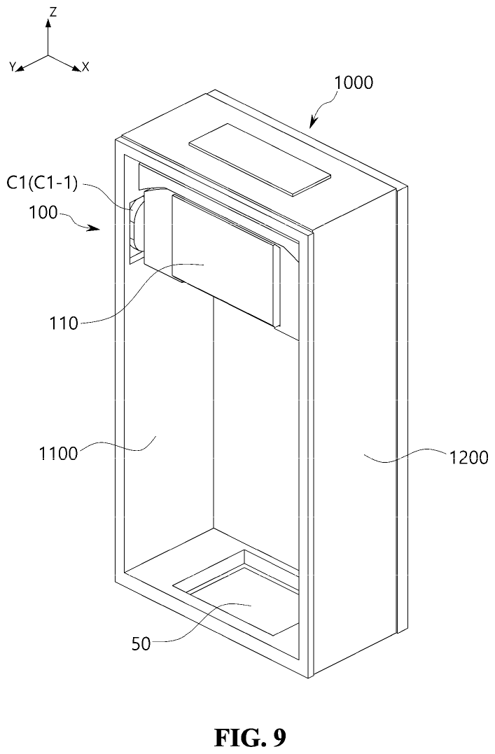

Even in the actuator 100 according to an embodiment of the present disclosure shown in FIGS. 9 and 10, the XZ plane becomes a plane direction (see FIG. 5) in which the carrier 120 rotates with the ball guide 130 as a relative stator, and the YZ plane becomes a plane direction (see FIG. 6) in which the carrier 120 of the present disclosure rotates with respect to the housing 140, 1100 or the support 140E, which is an extension of the housing 1100, together with the ball guide 130.

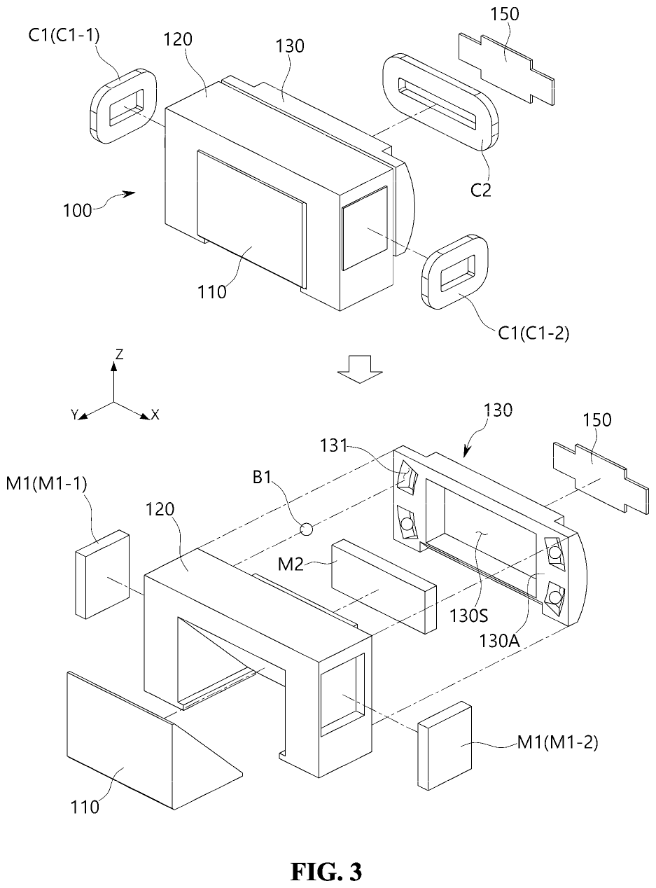

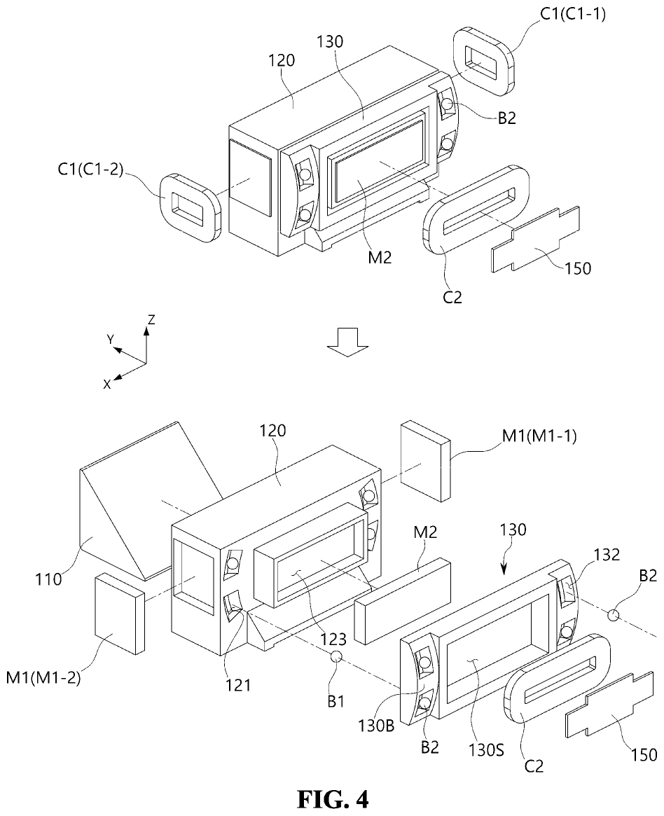

FIGS. 3 and 4 are exploded views showing the detailed configuration of the actuator 100 according to a preferred embodiment of the present disclosure.

As shown in FIG. 3 or the like, the actuator 100 according to an embodiment of the present disclosure may be configured to include a reflector 110, a carrier 120, a ball guide 130, and a housing 140 (see FIG. 5 or the like). As described above, the housing 140 of the actuator 100 may be the housing 1100 of the camera module 1000.

First, the overall configuration of the actuator 100 will be described with reference to the drawings, and the detailed configuration and driving relationship of the actuator 100 for OIS operation in each direction will be described later.

As described above, when the light of an object that is incident with a Z1 path flows into the actuator 100 of the present disclosure, the reflector 110 of the present disclosure changes (refracting, reflecting, or the like) the path of light to the optical axis direction Z and introduces the light into the lens 50, 60, 70.

The reflector 110 may be one of a mirror or a prism, or a combination thereof, and may also be implemented as a variety of members that can change the path of light introduced from the outside to the optical axis direction.

Since the actuator 100 of the present disclosure is configured so that the path of light is refracted by the reflector 110 and then flows into the lens 50, 60, 70, it is not necessary to install the lens driving module 200 itself in the thickness direction of a mobile terminal (smartphone or the like). Therefore, even if an optical member having a long physical characteristic in the optical axis direction, such as a zoom lens, is mounted to a portable terminal, the thickness of the portable terminal does not increase, which may be optimized for miniaturization of the portable terminal.

As well known in the art, OIS operation is implemented by moving the lens or the like in a direction that compensates for shaking caused by hand tremor. However, in the embodiment to which the present disclosure is applied, unlike the method of reverse-moving the lens or the like, OIS operation is implemented by moving the reflector 110.

Based on the example shown in FIG. 2, the reflector 110 of the present disclosure is installed at the actuator 100 in a direction in which light enters, namely in a direction toward the front surface in the Y-axis direction, and is fixed to the carrier 120 to physically move together with the carrier 120.

If the carrier 120 of the present disclosure makes rotational movement (based on the XZ plane) based on the ball guide 130 (as a relative stator) or the carrier 120 of the present disclosure makes rotational movement (based on the YZ plane) based on the housing 140 (as a relative stator) together with the ball guide 130, the reflector 110 installed at the carrier 120 also rotates in the same direction.

Preferably, a first ball B1 may be placed between the carrier 120 and the ball guide 130, and a second ball B2 may be placed between the ball guide 130 and the housing 140.

When the balls B1, B2 are interposed, the moving element may linearly move more stably due to minimized friction by the balls' rolling, moving, rotation, and point-contact to the facing object, and has the advantage of reducing noise, minimizing the driving force, and improving the driving precision.

As will be explained later, when the carrier 120 at which the reflector 110 is installed makes rotational movement based on the XZ plane with the ball guide 130 as a relative stator (see FIG. 5), the path of light flowing into the image sensor 30 moves to the X-axis direction due to the rotational movement of the reflector 110, and correct the hand tremor in the X-axis direction.

In addition, when the carrier 120 at which the reflector 110 is installed rotates based on the YZ plane together with the ball guide 130 (see FIG. 6), the path of light flowing into the image sensor 30 moves to the Y-axis direction due to the rotational movement of the reflector 110, and correct the hand tremor in the Y-axis direction.

In the following description, the direction in which the reflector 110 makes rotational movement on the plane corresponding to the XZ plane in relation to the image stabilization in the X-axis direction is referred to as a ‘first direction’, and the direction in which the reflector 110 makes rotational movement on the plane corresponding to the YZ plane in relation to the image stabilization in the Y-axis direction is referred to as a ‘second direction’.

In this respect, the ball guide 130 of the present disclosure corresponds to a stator in a relative relationship with the carrier 120 for the first direction rotational movement, but corresponds to a moving element in a relative relationship with the housing 140 for the second direction rotational movement.

Hereinafter, the detailed configuration and driving relationship of the actuator 100 for OIS driving in each direction will be described with reference to FIGS. 5 and 6.

As shown in the drawings, a first magnet M1 and a second magnet M2 arranged in directions perpendicular to each other are installed at the carrier 120 where the reflector 110 of the present disclosure is installed. Depending on the embodiment, the first magnet M1 (M1-1, M1-2) may be installed at the left and right sides of the carrier 120, respectively, as shown in the drawings.

The first and second coils C1 and C2 facing the first and second magnets M1 and M2, respectively, are installed in the housing 140. When a plurality of first magnets M1 are installed, the first coil C1 may also be installed in plurality (C1-1, C1-2).

When power of an appropriate magnitude and direction is applied to the first coil C1 through control of an operation driver (not shown), a magnetic force (electromagnetic force) is generated between the first coil C1 and the first magnet M1, and the carrier 120 makes rotational movement in the first direction based on the ball guide 130 (as a relative stator) using the generated magnetic force as a driving force (see FIG. 5).

As shown in the drawings, the first ball B1 is placed between the carrier 120 and the ball guide 130. The first ball B1 is provided on the first surface 130A, which is a surface facing the carrier 120 among the surfaces of the ball guide 130, and may be disposed such that a part thereof is accommodated between the first rail 131 having a rounded shape (e.g. track shape) and the first guider 121 provided at the carrier 120.

One of the first rail 131 and the first guider 121 may be implemented in a rail shape with a continuous or partially continuous groove, and may also be implemented in a pocket shape to prevent the first ball B1 from deviating outward.

Depending on the embodiment, the configuration for the above movement control may further include a detection sensor. In this case, when the detection sensor detects the position of the carrier 120 (specifically, the first magnet M1 or the sensing magnet installed at the carrier 120, or the like) and transmits the corresponding signal to the operation driver, the operation driver controls power of the corresponding magnitude and direction to be applied to the first coil C1.

The detection sensor may be implemented as a Hall sensor that detects the change in magnitude and direction of the magnetic field of a magnet present within the detection area using the Hall effect and outputs an electrical signal accordingly.

Meanwhile, the yoke plate 150 of the present disclosure plays a role of pulling the carrier 120 equipped with the second magnet M2 to the rear (Y-axis based on the drawings) by generating an attractive force to the second magnet M2.

Since the yoke plate 150 is installed in the housing 140 and the second magnet M2 is installed at the carrier 120, when an attractive force is generated between the yoke plate 150 and the second magnet M2, the carrier 120 is pulled toward the housing 140, so that the carrier 120 and the ball guide 130 with the first ball B1 interposed therebetween are closely adhered.

Due to this attractive force relationship, the point-contact between the first ball B1 and the carrier 120 and between the first ball B1 and the ball guide 130 may be continuously maintained.

From a corresponding point of view, when power of appropriate magnitude and direction is applied to the second coil C2 through control of the operation driver (not shown), a magnetic force (electromagnetic force) is generated between the second coil C2 and the second magnet M2, and the carrier 120 makes rotational movement in the second direction based on the housing 140 (as a relative stator) together with the ball guide 130 using the generated magnetic force as a driving force (see FIG. 6).

In addition, as shown in the drawings, the second surface 130B, which is the rear surface (based on the Y axis) of the ball guide 130, is provided with a rounded second rail 132, and the housing 140 facing the second surface 130B of the ball guide 130 has a second guider 142.

In this case, the second ball B2 may be placed between the second rail 132 and the second guider 142. Of course, as shown in the drawings, the second guider 142 may be in the form of an extended groove to accommodate a part of the second ball B2, or in the form of a pocket to prevent the second ball B2 from deviating outward.

In this way, the carrier 120 is in close contact with the ball guide 130 due to the attractive force caused by the yoke plate 150, and the second rail 132 and the second guider 142 with the second ball B2 interposed therebetween face each other. Thus, when a magnetic force is generated between the second coil C2 and the second magnet M2, the carrier 120 makes rotational movement (second direction rotation) along the rounded shape of the second rail 132 and/or the second guider 142 where the second ball B2 is interposed along with the ball guide 130.

In this respect, when the first direction rotational movement is driven, the ball guide 130 of the present disclosure functions as a stator in a relative relationship with the carrier 120 and supports the first direction rotational movement of the carrier 120. In addition, when the second direction rotational movement is driven, the housing 140 of the present disclosure functions as a stator in a relative relationship with the ball guide 130 and supports the second direction rotational movement of the ball guide 130.

The first rail 131 formed on the ball guide 130 may have a rounded shape like a track based on the XZ plane, as illustrated in the drawings, to guide the first direction rotational movement of the carrier 120. The second rail 132 may be formed in a rounded shape based on the YZ plane to guide the second direction rotational movement of the ball guide 130 along with the carrier 120.

The first rail 131 and the second rail 132 are formed in directions perpendicular to each other, and the second ball B2 is placed to be accommodated between the second rail 132 and the second guider 142. Therefore, when the carrier 120 makes the first direction rotational movement with the ball guide 130 as a relative stator through the guiding of the first rail 131, the second rail 132, second ball B2, second guider 142, and the like function as physical structures that suppress the rotational movement of the ball guide 130.

Due to this structural relationship, even if a magnetic force (electromagnetic force) is generated between the first magnet M1 and the first coil C1, the ball guide 130 may maintain a fixed position in relation to the housing 140.

From a corresponding point of view, when a rising or falling driving force (based on the Z axis) is generated at the second magnet M2 due to the magnetic force between the second magnet M2 and the second coil C2, the ball guide 130 makes rotational movement in the second direction (YZ plane) through the guidance of the second rail 132, the second guider 142, the second ball B2 interposed therebetween, or the like.

In this case, since the carrier 120 maintains a fixed position in relation to the ball guide 130 due to the restraining structure by the first rail 131, the first ball B1, and the first guider 121, the carrier 120 makes rotational movement in the second direction together with the ball guide 130.

The efficiency of this first direction or/and second direction rotational movement may be improved by the attractive force between the yoke plate 150 and the second magnet M2.

The first coil C1, the second coil C2, the Hall sensor, the operation driver, and the like may be mounted to a circuit board 1200 installed at the camera module 1000 or a circuit board provided in the actuator 100 itself. The circuit board 1200 is preferably configured so that a part thereof is exposed to the outside for interfacing with external modules, power supplies, external devices, or the like.

In the present disclosure, unlike the conventional actuators, the heterogeneous magnets M1 and M2 for OIS operation in each direction are not installed in different independent objects, but both of them are installed in one object, namely the carrier 120.

Therefore, it is possible to fundamentally solve the problem of the conventional actuator in which the posture or position of the object (moving element) at which an individual magnet is installed changes due to the magnetic force generated between the first and second magnets M1 and M2.

Meanwhile, the second magnet M2 of the present disclosure may be installed at the carrier 120 to protrude outward. Depending on the embodiment, as illustrated in the drawings, the second magnet M2 may be installed at the mounter 123, which is formed in a protruding form at the rear of the carrier 120, so that the second magnet M2 protrudes outward.

A space (hereinafter, referred to as a ‘first space’) may be formed in the ball guide 130 of the present disclosure, as shown in the drawings. In this case, the ball guide 130 of the present disclosure may be configured to face the carrier 120 in such a way that the second magnet M2 enters the first space 130S.

The size of the first space 130S is preferably designed sufficiently so that the second magnet M2 entering the first space 130S may make rotational movement by the first direction rotational movement of the carrier 120.

Since the actuator 100 of the present disclosure is configured to allow the second magnet M2 to enter the first space 130S as above, the attractive force generated between the second magnet M2 and the yoke plate 150 may be further enhanced.

In addition, due to the attractive force between the second magnet M2 and the yoke plate 150, the ball guide 130 located between the carrier 120 and the housing 140 may also naturally come into close contact with the carrier 120 located at one side as well as the housing 140 located at the other side.

Moreover, when the shape of the yoke plate 150 is implemented as a cross shape extending in the X-axis and Z-axis directions as illustrated in the drawings, after the first direction or/and second direction OIS operation is terminated, the efficiency of position return (centering) by which the ball guide 130 and the carrier 120 are restored to the initial positions (default positions) may be increased.

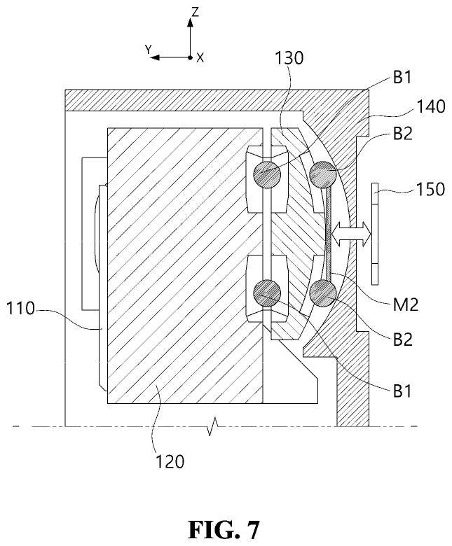

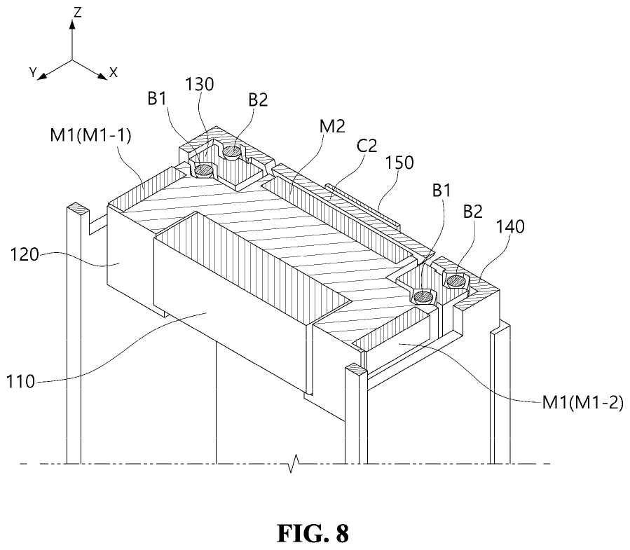

As shown in FIGS. 7 and 8, if the carrier 120 and the ball guide 130 of the present disclosure are arranged side by side in the same direction and an attractive force is generated between the yoke plate 150 and the second magnet M2 provided at the carrier 120 through the improved structure unique to the present disclosure described above, not only the carrier 120 but also the ball guide 130 is pulled backwards as a whole.

In addition, since the second magnet M2 is located close to the yoke plate 150 by penetrating the ball guide 130, the attractive force efficiency between the second magnet M2 and the yoke plate 150 may be maximized.

Therefore, through this improved structure, the present disclosure may more effectively implement both the adhesion force between the carrier 120 and the ball guide 130 with the first ball B1 interposed therebetween and the adhesion force between the ball guide 130 and the housing 140 with the second ball B2 interposed therebetween.

As described above, the first surface 130A, which is the surface facing the carrier 120 among the surfaces of the ball guide 130, may be provided with the first rail 131, and the second surface 130B, which is the surface opposite to the first surface 130A, may be provided with the second rail 132.

The first rail 131 and/or the second rail 132 are preferably configured to be provided outside the first space 130S, namely the space formed in the ball guide 130. In this case, to further increase structural engineering efficiency, the first space 130S may be formed in the center portion of the ball guide 130.

The first rail 131, along with the first ball B1, performs the function of physically supporting and guiding the first direction rotational movement of the carrier 120, which makes rotational movement with the ball guide 130 as a relative stator. Therefore, when the first rail 131 is formed outside the first space 130S as above, the first direction rotational movement of the carrier 120 may be guided more stably while minimizing tilt or clearance.

Since the second rail 132, along with the second ball B2, also guides the ball guide 130, which makes rotational movement in the second direction based on the housing 140, when the second rail 132 is formed outside the first space 130S, the second direction rotational movement may be guided more stably.

FIG. 9 is a diagram showing the overall configuration of an actuator 100 and a camera module 1000 according to another embodiment of the present disclosure, and FIG. 10 is an exploded view showing the detailed configuration of the actuator 100 depicted in FIG. 9.

The actuator 100 according to another embodiment of the present disclosure illustrated in FIG. 9 is different from the former embodiment of the present disclosure only in the positional relationship, but the technical idea is substantially the same.

As shown in FIG. 10, in the actuator 100 according to this embodiment, the ball guide 130 faces the carrier 120 and is located at the upper portion of the carrier 120 (based on the Z axis).

When a magnetic force is generated between the first magnet M1 and the first coil C1, the carrier 120 makes rotational movement based on the plane direction corresponding to the XZ plane based on the ball guide 130 (as a relative stator).

For this first direction rotational movement, the first rail 131 provided to the ball guide 130 and the first guider 121 provided to the carrier 120 may be formed in a rounded shape, which is so-called an arch-shape, based on the XZ plane.

The ball guide 130 faces the housing 140 or the support 140E, which is an extension of the housing 140, located at an upper side thereof (based on the Z axis), and when a magnetic force is generated between the second magnet M2 and the second coil C2, the ball guide 130 makes rotational movement based on the plane corresponding to the YZ plane.

Since the structure, operation, and positional relationships of the carrier 120, the ball guide 130, the housing 140, and the yoke plate 150 correspond to those described above, detailed descriptions thereof will be omitted.

The present disclosure has been described in detail. However, it should be understood that the detailed description and specific examples, while indicating preferred embodiments of the disclosure, are given by way of illustration only, since various changes and modifications within the scope of the disclosure will become apparent to those skilled in the art from this detailed description.

In the above description of this specification, the terms such as “first” and “second” etc. are merely conceptual terms used to relatively identify components from each other, and thus they should not be interpreted as terms used to denote a particular order, priority or the like.

The drawings for illustrating the present disclosure and its embodiments may be shown in somewhat exaggerated form in order to emphasize or highlight the technical contents of the present disclosure, but it should be understood that various modifications may be made by those skilled in the art in consideration of the above description and the illustrations of the drawings without departing from the scope of the present invention.

Reference Signs

| | |
|---|---|
| 1000: camera module | 1100: housing |
| 1200: circuit board | |
| 100: actuator | |
| 110: reflector | 120: carrier |
| 121: first guider | 123: mounter |
| 130: ball guide | |
| 130A: first surface | 130B: second surface |
| 131: first rail | 132: second rail |
| 136S: first space | |
| 140: housing | 140E: support |
| 142: second guider | 150: yoke plate |
| M1: first magnet | M2: second magnet |
| C1: first coil | C2: second coil |
| B1: first ball | B2: second ball |

What is claimed is:

1. An actuator for a reflector, comprising:
a carrier at which a reflector is installed;
first and second magnets installed at the carrier and placed in directions perpendicular to each other;
a ball guide configured to support rotational movement of the carrier in a first direction;
a first ball placed between the carrier and the ball guide;
a housing configured to support rotational movement of the ball guide in a second direction perpendicular to the first direction; and
a second ball placed between the ball guide and the housing.

2. The actuator for a reflector according to claim 1,
wherein the ball guide has a first space that is a space where the second magnet is exposed.

3. The actuator for a reflector according to claim 2,
wherein the second magnet is installed at the carrier to protrude outward, and
wherein the ball guide faces the carrier in such a way that the second magnet enters the first space.

4. The actuator for a reflector according to claim 2, further comprising:
a yoke plate provided in the housing and configured to generate an attractive force with the second magnet exposed through the first space.

5. The actuator for a reflector according to claim 4,
wherein the carrier and the ball guide are placed side by side in the same direction, and
wherein the yoke plate provides an adhesion force between the carrier and the ball guide with the first ball interposed therebetween and between the ball guide and the housing with the second ball interposed therebetween together by the attractive force with the second magnet.

6. The actuator for a reflector according to claim 2,
wherein the ball guide includes a rounded first rail where the first ball is placed, wherein the first rail is provided on a first surface, which is a surface facing the carrier, and is provided outside the first space.

7. The actuator for a reflector according to claim 6,
wherein the ball guide further includes a rounded second rail where the second ball is placed, wherein the second rail is provided on a second surface, which is a surface opposite to the first surface, and is provided outside the first space.
